(19) United States
(12) Patent Application Publication
(10) Pub. No.: US 2008/0209529 A1
(43) Pub. Date: Aug. 28, 2008

(54) TRANSACTION INTEGRITY AND AUTHENTICITY CHECK PROCESS

(75) Inventor: Douglas Tevis Francisco, Barueri (BR)

Correspondence Address: DARBY & DARBY P.C., P.O. BOX 770, Church Street Station, New York, NY, 10008-0770, US

(73) Assignee: Banco Bradesco S.A., Osasco (BR)

(21) Appl. No.: 12/036,051

(22) Filed: Feb. 22, 2008

(30) Foreign Application Priority Data
Feb. 26, 2007 (BR) PI700706

(51) Int. Cl. H04L 9/32

(52) U.S. Cl. 726/6

(57) ABSTRACT

The present invention refers to a process of transaction authenticity and integrity check that allows the user to verify the authenticity of an internet bank site. Said process does not require the use of special devices by the users, thus avoiding extra implementation costs and making its adoption easy.

### FIELD OF THE INVENTION

The present invention refers to a transaction integrity and authenticity check process, to be specifically used on bank sites for services through the Internet, on transactions and electronic data transmissions.

### BACKGROUND OF THE INVENTION

The exposition that follows, for simplicity of explanation, illustrates the invention according to a particular embodiment, which is a transaction integrity and authenticity check process carried out including, but not limited to, on bank sites for services through the Internet; and may be used to check user's data when accessing any sort of database and/or information.

Artisan in the art are familiar with the use of passwords to control database access. Usually, in order to keep access control to certain database, user is requested to present his/her “user name” and “password”, thus limiting access only to people authorized by the system. User name and password are formed by letters and numbers and are typed on the computer keyboard. If the password typed is correct access to net is granted, and if it is wrong, access is denied.

Alpha numeric system, however, presents a few disadvantages.

It is usually advised that the password be formed by a combination of random letters and numbers, different from names and dates that could, by trial and error, be easily disclosed by smugglers. However, as one tries to make disclosure more difficult, memorization becomes more difficult for the user.

Another issue that one may face is the interception of password or any other data during internet transmission. There are several cryptography techniques to encrypt data and stop data captured in a non authorized way. Even with the use of cryptography, confidential information may still be deciphered, allowing for their undue use.

There are also the well known “Trojans” or Trojan Horses which are executable software that take over total or partial control of the infected PC for malicious purposes. It is thus possible to steal passwords to make copies or destroy files, etc.

Another manner of mischief used by third parties in order to take property of data belonging to other parties on the Internet is to induce network users themselves to supply said information. This may be done by means of E-mails containing fake messages of default using names of well known institutions; sites containing free services to collect private data; virtual shops to obtain credit card numbers and other information from consumers, faithful copies of bank homepages leading clients to access them in order to provide their account numbers, passwords, etc.

In order to make the system safer, some safety measures may be taken to validate the user identity associated to alphanumeric passwords, such as to scan and assess digital fingerprint, retina, users face, blood veins pattern or voice recognition.

The fact is that these safety systems may not always be implemented on home PCs, as they depend on specific peripherals as scanner, camera, and microphone.

Thus, though efficient, these imply additional cost to user, making it difficult its implementation, and therefore, proving inconvenient.

An alternative to these systems are the digital certificates and tokens (numbers generated by the use of cryptography and hash) so as to create a transaction signature. But this certification, in an unfavorable manner, also needs external devices on the part of users, making its use more expensive.

The following patent documents, that reveal data examining systems, that differently from this invention are more complex and take longer to be executed, may also be mentioned.

For instance, the American patent U.S. Pat. No. 6,209,104 refers to a system where the server generates images containing icons placed on strategic sites, whose location is stored in association to them. When client inserts password, he chooses a series of icons that are associated to his password until he gets it right. Said system is not convenient to the user who, aside from having to remember his password, has to associate it to images while choosing the icons.

European patent EP 677 801 provides a graphic password to the user, so that, when a user tries access to the database, an image is presented on the monitor that should be touched (or clicked) on certain areas and on a certain order, as a password that is determined by means of the coordinates of the touched points. This system, though effective, is very complex for its implementation, as it demands user to remember the correct order of touches.

The object of the present invention is, therefore, an on-line integrity and authenticity transaction check process without the use of specific devices on the part of the users, avoiding extra implementation costs and making its adoption simpler.

The proposed process decreases considerably the risk of violation of transaction data integrity, using a simple means of communication (image) applicable to a large spectrum of users' profiles.

### SUMMARY OF THE INVENTION

It concerns to a transaction integrity and authenticity check process to be used by clients of a banking institution, through its Internet site, as a means of avoiding third parties to violate data integrity.

The site offers the client the choice to opt for one among many images. The client selects any one, at its discretion. Image choice may be made in several ways, such as clicking on it with the help of a mouse, or with the help of a keyboard using the key TAB to manipulate the cursor of an image to another and the key ENTER for choosing; or with arrow keys (|, |, <-, −+) to go from one image to the other, until getting to the desired one, and then pressing the key ENTER, etc. In case of a touch sensitive screen, image choice can be made by touching said image.

The chosen image is then associated to the client and it operates as a bank transaction signature, so, whenever the client confirms a transaction, it will be there, serving as a kind of counter password.

Thus, the client may acknowledge the authenticity of the bank site and the information of the required transaction whenever the image he chooses is presented.

In the event of an interception of the transaction data or if a fake site appears to client, client will then notice the lack of the chosen image or change in data, thus not confirming the transaction that will then be discarded.

The image will consist of a sort of secret between the bank and the client, to be used when the bank transaction is done electronically, being a kind of authenticity element of the bank by the client.

Optionally the image may be presented by the client himself, and it is then elaborated by the institution so as to promote information related to the transaction, such as: value of the transaction, name of the client and/or beneficiary, etc.

As an alternative, the image may be cryptographed and/or written shorthand for its transmission, ensuring its integrity and preventing violation.

This process allows the examination of the legitimacy of the origin of the transaction and of the integrity of its data.

### A BRIEF DESCRIPTION OF DRAWINGS

Next, a particular way of the invention will be described, based on the attached drawings, without imposing any limits to the scope of the invention set forth by the attached claims, in which:

FIG. 1 represents a block diagram of the counter-password choice; and,

FIG. 2 represents a block diagram of the bank transaction with the image chosen by the client.

### DETAILED DESCRIPTION OF THE INVENTION

The present invention refers to an authenticity and integrity transaction check process to verify the integrity of an internet bank site by the client.

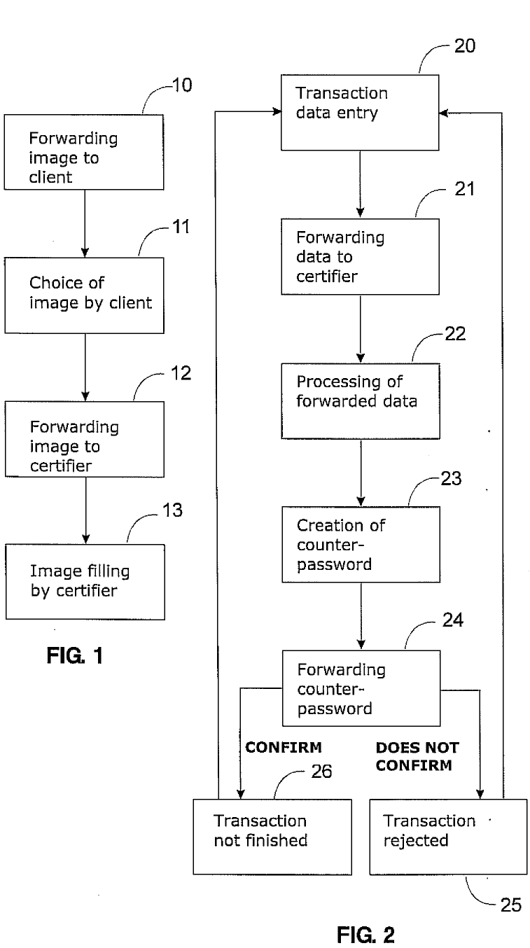

FIG. 1 shows a block diagram of a process for the choice of image to be made available to a client at a site of a bank institution, for instance, by means of a personal computer, self service terminal, bank agencies computers, etc.

The expression “certifier” is used here to describe the entity that verifies the authenticity of transactions, generates and forwards the “counter password image” and assesses the client return to it.

The process is implemented by a certifier that forwards the images by electronic means to a computer, where it is then selected by the client. This process stores the selected image, associating it to the client. Throughout the examination process, it mixes the transaction data with image associated with the client creating a sort of a counter-password that is examined by the client for a further transaction confirmation.

The invention consists basically in providing a plurality of images (stage 10) to the client that, once chosen (stage 11) will become a part of the client's counter-password when using electronic bank services. Thus, the counter-password is an image that, along with data of a bank transaction chosen by the client, when acknowledged, allows the conclusion of an electronic bank transaction. Its use prevents unauthorized third parties real time data copy, cloning and change. In order for that, the image choice comprises the following stages shown on picture 1:

a) forwarding to client, by certifier, a number of electronic images (stage 10);

b) choice (stage 11) of one of the images by the client;

c) forwarding the chosen image to the certifier (stage 12);

d) loading image on the certifier, linking it to the client (stage 13).

The terms “electronic way” and “electronic means” used herein refer to any form of data forwarding as Internet, Intranet, electronic sign, etc.

Optionally, the image may be forwarded by the client to the certifier. This image may be as any such as a picture, a scanned image, etc.

Once the image is chosen by the client (stage 11) it is stored on the certifier (stage 13) waiting for any transaction eventually required. Once client access the bank institution homepage and requires a transaction, the certifier will send back a counter-password formed from the image chosen with some of the transaction data. According to the counter-password, the client confirms and the certifier authorizes the transaction. In case the client does not confirm, the transaction is discharged.

In the present transaction integrity and authenticity check process the generation of a counter-password is made in the request of a bank transaction, being the process carried out as per the following stages:

a) Entry of transaction data by the client (stage 20);

b) Transaction data forwarding to the certifier (stage 21);

c) Processing by certifier of received data (stage 22);

d) Creation of a counter-password from an image previously filed by the client with one or more data of the transaction forwarded by the client (stage 23);

e) Forwarding of counter-password to the client (stage 24);

f) Confirmation by client, the certifier carries out the transaction (stage 26), returning to stage 20;

a) Non confirmation by the client, certifier rejects pending transaction (stage 25), returning to stage 20.

Thus, transaction may only be confirmed by the client who chose the image. In case a third party homepage feigning that of the bank appears on the screen during operation of access to actual page, the client will notice the absence of the previously chosen image, and thus will see this is a fake homepage, and will not carry on any transaction.

It is important to notice that the invention depends on technological means to reach its goals that are practical and concrete.

The artisan in the art will promptly note, from the description and attached drawings, several ways for realizing the invention without departing from the scope of the attached claims.

What is claimed is:

1. A transaction and authenticity check process comprising the following stages:
a) entry of transaction data by a client;
b) transaction data forwarding to a certifier;
c) processing by the certifier of received data;
d) creation of a counter-password from an image linked to the client with one or more data of the transaction forwarded by the client;
e) forwarding of the counter-password to the client;
(2) the certifier carries out pending transaction when the transaction is confirmed by the client; and
a) the certifier denies pending transaction when the transaction is denied by the client.

2. The transaction integrity and authenticity check process according to claim 1, wherein the creation step comprises the steps of:
a) forwarding to the client a number of electronic images by the certifier;
b) choice of one of the images by the client;
c) forwarding the chosen image to the certifier;
d) loading the image on the certifier; and
e) linking it to the client's bank account.

3. The transaction and authenticity check process according to claim 1 wherein the process presents to the client more than one image along with that previously chosen on step (e), to confirm the transaction.

4. The transaction and authenticity check process according to claim 1 wherein the image is provided by the client.

5. The transaction integrity and authenticity check process according to claim 1 wherein the image is cryptographed or written in short hand for its transmission.

6. The transaction integrity and authenticity check process according to claim 2 wherein the forwarding step forwards the electronic images over the internet.

7. The transaction integrity and authenticity check process according to claim 2 wherein the image is provided by the client.

8. The transaction integrity and authenticity check process according to claim 2 wherein the image is cryptographed or written in short hand for its transmission.

9. The transaction integrity and authenticity check process according to claim 3 wherein the image is cryptographed or written in short hand for its transmission.

10. The transaction integrity and authenticity check process according to claim 4 wherein the image is cryptographed or written in short hand for its transmission.

| Forwarding image to client (10) | Transaction data entry (20) | |
|---|---|---|
| Choice of image by client (11) | Forwarding data to certifier (21) | |
| Forwarding image to certifier (12) | Processing of forwarded data (22) | |
| Image filling by certifier (13) | Creation of counter-password (23) | |
| | Forwarding counter-password (24) | |
| | Confirms | Does not confirm |
| | Transaction not | Transaction |
| | finished (26) | rejected (25) |
